(19) United States
(12) Patent Application Publication
(10) Pub. No.: US 2024/0120770 A1
(43) Pub. Date: Apr. 11, 2024

(54) BATTERY ENERGY STORAGE SUPPLEMENTAL POWER

(71) Applicant: Rosendin Electric, Inc., San Jose, CA (US)

(72) Inventors: Steve Emert, Menlo Park, CA (US); William Paul Mazzetti, San Francisco, CA (US)

(21) Appl. No.: 18/375,875

(22) Filed: Oct. 2, 2023

Related U.S. Application Data
(60) Provisional application No. 63/413,567, filed on Oct. 5, 2022.

(51) Int. Cl. H02J 9/06; H02J 7/00

(52) U.S. Cl. CPC H02J 9/068; H02J 7/0068; H02J 9/061; H02J 9/062

(57) ABSTRACT

A BESSP platform mitigates power changes from instantaneous i) startup electrical currents and/or ii) other in-rush electrical currents compared to a steady state electrical current. An electrical controller electrically connects to a remote electrical tap and sensor to sense characteristics of power coming from a main power source. The electrical controller is configured to discharge the batteries to mitigate a swing past the threshold amount from the steady state electrical current caused by the instantaneous i) startup electrical currents and/or ii) other in-rush electrical currents back up to the steady state electrical current; and thus, prevent the swing from the steady state electrical current caused by the instantaneous i) startup electrical currents and/or ii) other in-rush electrical currents from reaching and affecting electrical equipment loads connected to the BESSP platform.

### RELATED APPLICATIONS

This application claims priority under 35 USC 119 to both U.S. provisional patent application Ser. 63/413,567, titled “BATTERY ENERGY STORAGE SUPPLEMENTAL POWER,” filed 5 Oct. 2022.

### FIELD

Embodiments of the design relate to Electrical Power Distribution.

### BACKGROUND

Diesel generators and other electrical generators can be used to provide power.

### SUMMARY

Methods systems, and apparatus are disclosed for a Battery Energy Storage Supplemental Power platform (BESSP).

In an embodiment, a Battery Energy Storage Supplemental Power (BESSP) platform mitigates power changes from instantaneous i) startup electrical currents and/or ii) other in-rush electrical currents compared to a steady state electrical current. The BESSP platform can include, at least, a set of batteries making up a battery storage plant, a bidirectional power conversion unit, and a set of circuit breakers. The battery storage plant, the bidirectional power conversion unit, and the circuit breakers are contained on and electrically interconnected on the BESSP platform.

An electrical controller, such as a programmable logic controller, controls and coordinates both i) a discharging of the batteries making up the battery storage plant when a large threshold amount of the instantaneous i) startup electrical currents and/or ii) other in-rush electrical currents compared to the steady state electrical current are sensed and ii) a charging of the batteries making up the battery storage plant when the batteries 1) are not in a mode to discharge and 2) are in a state of being less than fully charged. The electrical controller is electrically connected to a remote electrical tap and sensor to sense characteristics of power coming from a main power source. The electrical controller is configured to discharge the batteries to mitigate a swing past the threshold amount from the steady state electrical current caused by the instantaneous i) startup electrical currents and/or ii) other in-rush electrical currents back up to the steady state electrical current; and thus, prevent the swing from the steady state electrical current caused by the instantaneous i) startup electrical currents and/or ii) other in-rush electrical currents from reaching and affecting electrical equipment loads connected to the BESSP platform.

These and many more embodiments are discussed.

### BRIEF DESCRIPTION OF DRAWINGS

The drawings refer to example embodiments of the invention included in this document and submitted with this document.

FIG. 1A illustrates an example single line diagram of the Battery Energy Storage Supplemental Power (BESSP) platform that shows the electrical interconnectivity of the BESSP equipment.

FIG. 1B below illustrates an example BESSP platform supplying power to example loads.

FIG. 2 illustrates an example BESSP container equipment layout, such as a set of batteries making up a battery storage plant, a bidirectional power conversion unit, switchboard, power panel, electrical controller (electronics), and a set of circuit breakers, in a BESSP container.

FIG. 3 illustrates an example application of the BESSP platform to supply supplemental power to electrical loads to mitigate a swing past the threshold amount from the steady state electrical current caused by the instantaneous i) startup electrical currents and/or ii) other in-rush electrical currents back to the steady state electrical current; and thus, prevent the swing from the steady state electrical current caused by the instantaneous i) startup electrical currents and/or ii) other in-rush electrical currents from reaching and affecting electrical equipment loads connected to the battery energy storage supplemental power platform.

FIG. 4 illustrates another example application of the BESSP platform to supply supplemental power to electrical loads and discharge the batteries making up the battery storage plant when a threshold amount of the instantaneous i) startup electrical currents and/or ii) other in-rush electrical currents compared to the steady state electrical current is sensed.

FIGS. 5A-5C illustrate a flow diagram of example operations of the BESSP platform.

FIG. 6 illustrates a block diagram of an embodiment of one or more computing devices that can be a part of the electronic controller and other parts of the BESSP platform discussed herein.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific data signals, named components, connections, amount of emergency power supplies, etc., in order to provide a thorough understanding of the present invention. It will be apparent, however, to one of ordinary skill in the art that the present invention may be practiced without these specific details. In other instances, well known components or methods have not been described in detail but rather in a block diagram in order to avoid unnecessarily obscuring the present invention. Further specific numeric references such as first enclosure, may be made. However, the specific numeric reference should not be interpreted as a literal sequential order but rather interpreted that the first enclosure is different than a second enclosure. Thus, the specific details set forth are merely exemplary. The specific details may be varied from and still be contemplated to be within the spirit and scope of the present invention.

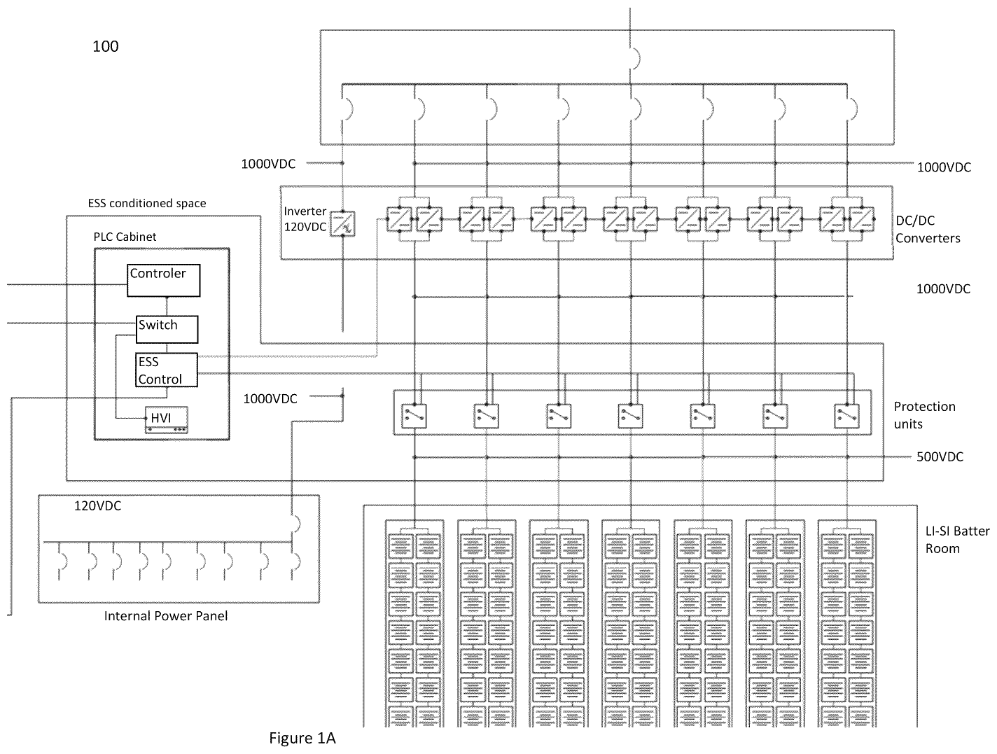

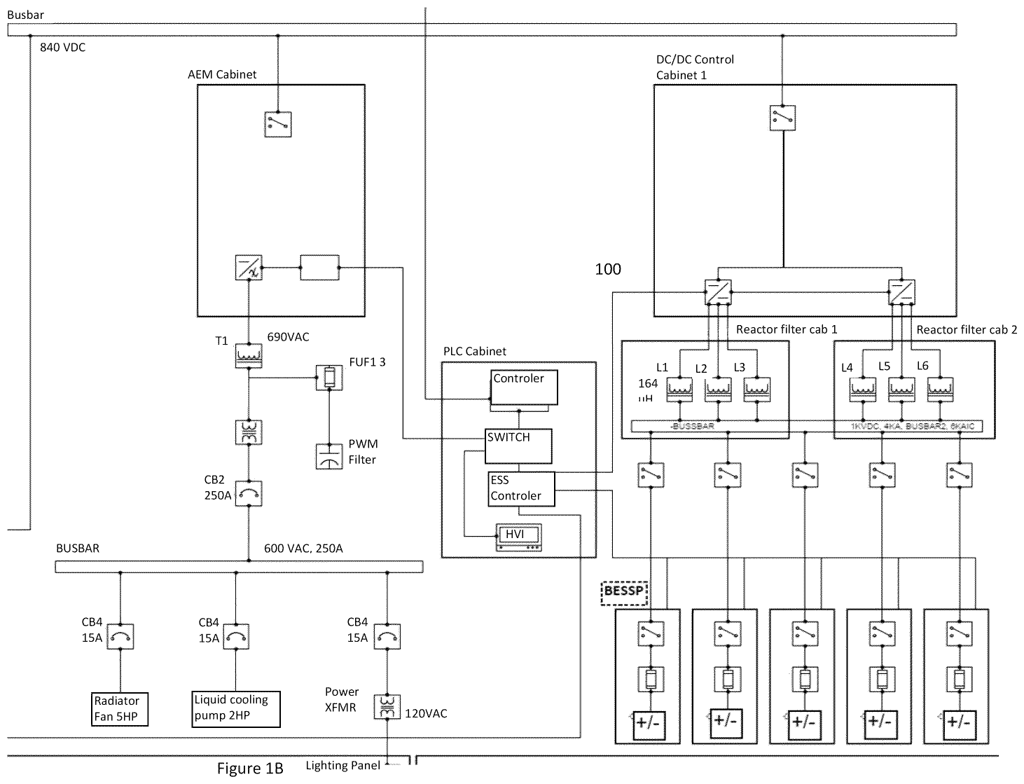

FIG. 1A illustrates an example single line diagram of the Battery Energy Storage Supplemental Power (BESSP) platform that shows the electrical interconnectivity of the BESSP equipment.

In an embodiment, the BESSP platform 100 incorporates components from battery energy storage systems and DC power supply systems to provide supplement power to remote off-grid systems. The BESSP platform 100 can be used mitigate large electrical power inrush events. The BESSP platform 100 eliminate the need for a spinning reserve power as well as a need to have an extra diesel generator online to support the startup of large motors is cost effective. The BESSP platform 100 can be used in any application which requires excessive and repetitive startup or in-rush electrical currents where a surge on a demand of electrical current occurs often.

The BESSP platform 100 mitigates power changes from instantaneous i) startup electrical currents and/or ii) other in-rush electrical currents compared to a steady state electrical current. The BESSP platform 100 can include, at least, a set of batteries making up a battery storage plant, a bidirectional power conversion unit, and a set of circuit breakers. The battery storage plant, the bidirectional power conversion unit, and the circuit breakers are contained on and electrically interconnected on the BESSP platform 100.

An electrical controller, such as a programmable logic controller, controls and coordinates both i) a discharging of the batteries making up the battery storage plant when a large threshold amount of the instantaneous i) startup electrical currents and/or ii) other in-rush electrical currents compared to the steady state electrical current are sensed and ii) a charging of the batteries making up the battery storage plant when the batteries 1) are not in a mode to discharge and 2) are in a state of being less than fully charged. The electrical controller is electrically connected to a remote electrical tap and sensor to sense characteristics of power coming from a main power source. The electrical controller is configured to discharge the batteries to mitigate a swing past the threshold amount from the steady state electrical current caused by the instantaneous i) startup electrical currents and/or ii) other in-rush electrical currents back up to the steady state electrical current; and thus, prevent the swing from the steady state electrical current caused by the instantaneous i) startup electrical currents and/or ii) other in-rush electrical currents from reaching and affecting electrical equipment loads connected to the BESSP platform 100.

In an embodiment, the integrated electrical power platform making up the Battery Energy Storage Supplemental Power platform 100 can include two or more sequences of a battery storage plant, a power conversion unit, circuit breakers/electrical protections connected electrically in parallel with another sequences of these same electrical components. An electrical controller, such as programmable logic controller, controls and coordinates the charging and discharging of the sequences of battery storage plants, power conversion units, circuit breakers/electrical protections connected electrically in parallel with each other. The multiple sequences of the battery storage plant, the power conversion unit, and circuit breakers/electrical protections are contained and interconnected on a platform such as a skid framework in weather-proof containers. The skid framework can contain integrated wheels or at least attachments to attach wheels to make the BESSP platform 100 mobile.

The bidirectional power conversion unit can be implemented in multiple ways. In an embodiment, the bidirectional power conversion unit is an AC to DC power conversion and DC to AC power conversion unit. In an embodiment, the bidirectional power conversion unit is an DC to DC power conversion unit that is configured to convert from a first steady state DC voltage level, such as a battery voltage of 30 volts, to a different second steady state DC voltage level, such as a 1000 VDC supplied to the electrical loads. The power conversion unit includes i) electrical components (e.g., converters) that perform an electrical power conversion of DC power supplied at a first level of voltage, for example, 30-50 VDC from its corresponding battery storage plant up to a second level of voltage, the operating voltage level of the system that the BESSP is providing supplement power to. Thus, the power conversion unit can provide an output, such as 1000 VDC, to provide a supplemental source of power that cooperates with another electrical power generating source supplying power to that recipient system.

The electrical controller communicates and directs the other electrical components in the BESSP platform 100 to supply regulated and conditioned DC power to stay within a set voltage level, which eliminates swings in voltage amplitude that are outside the set regulated and conditioned DC voltage level even when the DC power supplied from a main DC power source would normally have swings in voltage level due to the electrical inrush. The BESSP platform 100 prevents voltage swings from reaching and affecting the electrical equipment loads by providing the instantaneous amperage needed by heavy equipment at the beginning of an operation of moving something, such as a crane lifting heavy loads, a drill rig lifting heavy cable loads, etcetera.

The battery storage plant of the BESSP platform 100 can use rapid discharge and recharge batteries. In an embodiment, the rapid discharge and recharge batteries, such as Silicon-Ion batteries, to replace the existing super capacitor technology. Silicon-Ion batteries can perform better and cost less than the existing super capacitor technology. Thus, the batteries can be Silicon-Ion based batteries to support a rapid discharge of energy from the batteries and a frequent recharge of the batteries as well as the electrical controller is configured to rapidly switch a mode of operation of the battery storage plant, the power conversion unit, and the circuit breakers from being a local source of additional instantaneous electrical power over to a charging mode to replenish energy into and charge the batteries.

The battery storage plant can have a capacity in amp-hours (Ahrs) to provide a continuous supplemental source of DC power to supply the electrical equipment loads connected downstream.

In an embodiment, the BESSP platform 100 incorporates components from Battery Energy Storage Systems (BESS) and DC power supply systems to provide supplement power to remote off-grid systems. The BESSP platform 100 can be used to mitigate large electrical power inrush events. The BESSP platform 100 eliminates the need for a spinning reserve power as well as a need to have an extra diesel generator online to support the startup of large motors is cost effective. The BESSP platform 100 can be used in any application which requires excessive and repetitive startup or in-rush electrical currents where a surge on a demand of electrical current occurs often.

In an embodiment, the integrated electrical power platform making up the Battery Energy Storage Supplemental Power platform 100 can include two or more sequences of a battery storage plant, a power conversion unit, circuit breakers/electrical protections connected electrically in parallel with another sequences of these same electrical components. An electrical controller, such as programmable logic controller, controls and coordinates the charging and discharging of the sequences of battery storage plants, power conversion units, circuit breakers/electrical protections connected electrically in parallel with each other. The multiple sequences of the battery storage plant, the power conversion unit, and circuit breakers/electrical protections are contained and interconnected on a platform such as a skid framework in weather-proof containers. The skid framework can contain integrated wheels or at least attachments to attach wheels to make the BESSP platform 100 mobile. Thus, the battery energy storage supplemental power platform has a skid framework that contains 1) integrated wheels or 2) at least attachments to attach wheels to make the battery energy storage supplemental power platform mobile.

The power conversion unit includes i) electrical components (e.g., converters) that perform an electrical power conversion of DC power supplied at a first level of voltage, for example, 30-50 VDC from its corresponding battery storage plant up to a second level of voltage, the operating voltage level of the system that the BESSP platform 100 is providing supplement power to. Thus, the power conversion unit can provide an output, such as 1000 VDC, to provide a supplemental source of power that cooperates with another electrical power generating source supplying power to that recipient system.

The electrical controller communicates and directs the other electrical components in the BESSP platform 100 to supply regulated and conditioned DC power to stay within a set voltage level, which eliminates swings in voltage amplitude that are outside the set regulated and conditioned DC voltage level even when the DC power supplied from a main DC power source would normally have swings in voltage level due to the electrical inrush. The BESSP platform 100 prevents voltage swings from reaching and affecting the electrical equipment loads by providing the instantaneous amperage needed by heavy equipment at the beginning of an operation of moving something, such as a crane lifting heavy loads, a drill rig lifting heavy cable loads, etcetera.

The battery storage plant of the BESSP platform 100 can use rapid discharge and recharge batteries. In an embodiment, the rapid discharge and recharge batteries, such as Silicon-Ion batteries, to replace the existing super capacitor technology. Silicon-Ion batteries can perform better and cost less than the existing super capacitor technology.

The battery storage plant can have a capacity in amp-hours (Ahrs) to provide a continuous supplemental source of DC power to supply the electrical equipment loads connected downstream.

The integrated electrical power platform making up the Battery Energy Storage Supplemental Power platform 100 combines modified components from A) a Battery Energy (chemical energy) Storage System (BESS) and B) a DC Power Supply System in order to have a single device/unitary piece of electrical gear configured to cooperate with another source of power to critical electrical equipment loads in a facility. Note, the BESSP platform 100 may also include a DC voltage to AC voltage to provide a similar function for critical electrical equipment loads power by AC power in a facility.

The overall BESSP platform 100 can consist of a set of one or more integrated electrical power units, its/their electrical controller, their associated circuit breakers/and other over current and under voltage protection mechanisms, a switchboard and other similar electrical gear integrated into a single platform that is potentially mobile.

Each BESSP platform 100 has multi-modes of operation that allow the device to switch rapidly from being a local source of additional instantaneous electrical power over to a charging mode to replenish and charge the batteries.

Again, the power conversion module can include i) electrical components (e.g., voltage inverters, voltage regulators, electrical filters, uninterruptable power supply, etc.) to perform an electrical power conversion to step up the DC power at a lower voltage supplied from the batteries to the DC voltage level power going the electrical loads as well as the step down voltage conversion needed to put charge from the other higher main DC voltage source of power supplying power to the electrical load to put charge into the battery storage plant. The other main DC voltage source may be, for example, a diesel generator connected to an AC to DC converter.

The BESSP platform 100 can use the Silicon-Ion battery technology to supplement the power requirements when operating large motors in an off-grid environment. Silicon-ion batteries as opposed to other battery technologies have very high rapid discharge and recharge capabilities.

The BESSP platform 100 can be comprised of the following example components:
Silicon-ion batteries;
a BMS [Battery Monitoring System];
a BPS [Battery Protection System];
DC/DC Converters; and
a DC Collection Switchboard.

The BESSP platform 100 are containerized. The containers are mobile. A the BESSP platform 100 can be easily manufactured offsite and then transported to the job site and then from job site to job site.

Each BESSP platform 100 may consist of one or more battery storage plants (labeled Battery), each battery storage plant including a scalable amount of batteries, and one or more power electrical power conversion module (PSCM) to bilaterally convert the voltage level into and out of the integrated electrical power unit. The electrical power conversion module converts electrical energy through rectifiers and inverters, electrical filters, and regulators. Thus, the battery energy storage supplemental power platform 100 has an expansion connection to allow an additional battery energy storage supplemental power platform 100 to connect electrically in parallel with the battery energy storage supplemental power platform 100; and thus, be scalable in an amount of capacity over time of its operation by having the expansion connection to add on additional electrical power capacity from the additional battery energy storage supplemental power platform.

Again, an example single line diagram of the BESSP platform 100 with the example electrical components, such as a set of batteries making up a battery storage plant, a bidirectional power conversion unit, and a set of circuit breakers, making up the BESSP. The BESSP single line diagram shows the interconnectivity of the BESSP equipment.

The BESSP platform 100 use the Silicon-Ion battery technology to supplement the power requirements when operating large motors in an off-grid environment. Silicon-ion batteries as opposed to other battery technologies have very high rapid discharge and recharge capabilities. The BESSP platform 100 is comprised of the following components: Silicon-ion batteries; a Battery Monitoring and Management System including a PLC cabinet; a Battery Protection System; DC/DC Converters; and a DC Collection Switchboard.

The BESSP single line diagram represents how the components described above are interconnected. In this example, the BESSP has seven (7) strings of Silicon-ion batteries. Each string of Silicon-ion batteries has fourteen (14) battery cells with example Ratings: 25 kW at 750A @ 32 VDC, and an Integral Battery Monitoring System (BMS). The BESSP platform 100 has seven (7) DC protection string systems. Each DC protection string system has a DC circuit breaker, a DC fuse, a DC contactor, and Protective Electronics. The BESSP platform 100 has fourteen (14) Bi-Directional DC-to-DC converters (rated at full string ampacity). The BESSP has seven DC to DC converters. The BESSP platform 100 has one (1) DC-to-AC inverter to support AC electrical loads on the BEESP platform 100 (e.g., rated 50 kW, 208/120V, 3 phase, 4 wire). The BESSP platform 100 has a Distribution Panelboard (e.g., rated 225A, 208/120V, 3 phase, 4 wire). The BESSP platform 100 is on a skid and containerized in potentially weatherproof enclosures. The BESSP platform 100 has fully ‘self-contained’ systems. The battery energy storage supplemental power platform is constructed with material to withstand weather and outdoor conditions in a weatherized container as well as rapidly and frequently dissipate heat from frequent discharging and charging the batteries of the battery storage plant. In large motor operations, such as a crane, the batteries will need to discharge the batteries to make up the instantaneous in rush currents for several milliseconds and then while the current has hit a steady state electrical current then the BESSP platform 100 can stop discharging. After an amount of discharges, when the battery levels are at, for example, 90%, then the electrical controller will switch over to charging the batteries.

Next, each battery storage plant with its backup battery power packs can also be scalable in both its energy storage capacity by simply stacking more battery cells connected electrically in series-parallel in its battery storage plant.

FIG. 1B below illustrates an example BESSP platform 100 supplying power to example loads. The BESSP platform 100 connects with the main source of power to maintain the voltage level during large inrush surges. The battery energy storage supplemental power platform has a line reactor to compensate for and eliminate at least one or more of i) surges, ii) transients, and iii) harmonics issues to an AC voltage level, frequency, and phase of the AC voltage occurring in the AC power coming from the main power source from reaching and affecting electrically connected electrical equipment loads.

The BESSP platform 100 supports example large motor operations, which consume a lot of power when starting up and/or engaging in moving heavy loads.

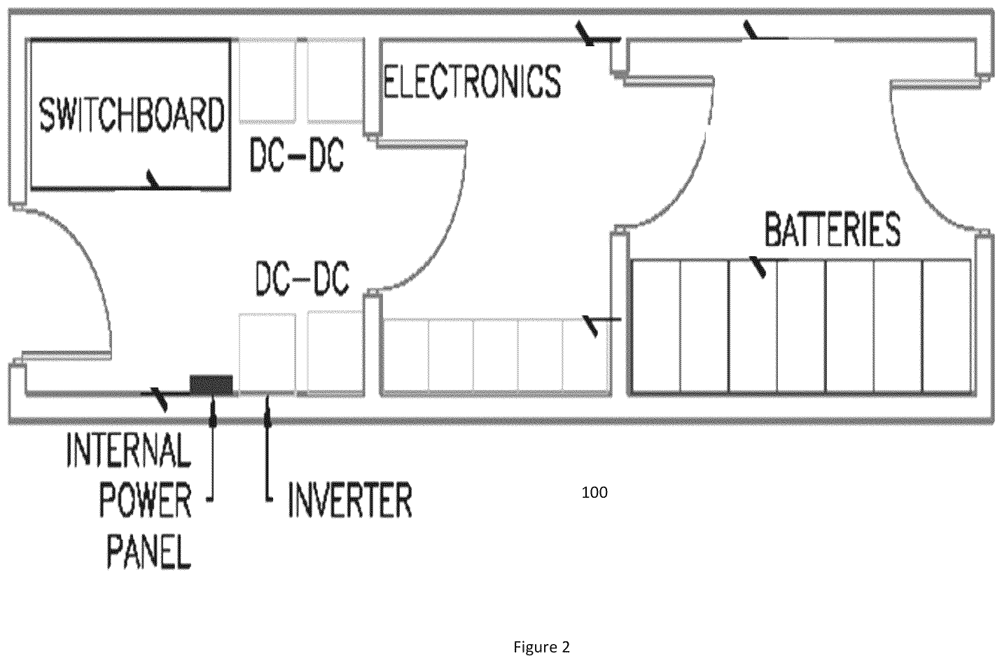

FIG. 2 illustrates an example BESSP container equipment layout, such as a set of batteries making up a battery storage plant, a bidirectional power conversion unit, switchboard, power panel, electrical controller (electronics), and a set of circuit breakers, in a BESSP container. All BESSP components of the system can be packaged in, for example, 44′×11′ containers.

On the BESSP platform in the containers the following equipment can be found:
Silicon-ion batteries,
DCP electronics including the electronic controller,
BESSP System Controls,
DC-to-DC converters,
DC-to-AC inverter,
Internal power distribution panel,
DC collector/Switchboard,
HVAC as required,
Lighting,
Security,
Fire Detection, and
Fire Suppression.

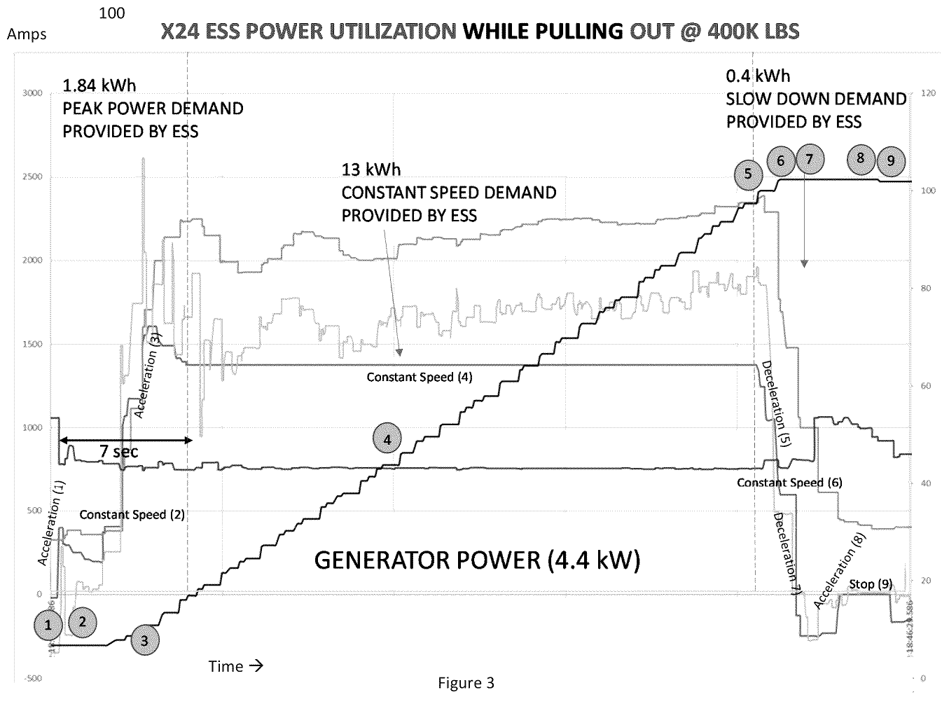

FIG. 3 illustrates an example application of the BESSP platform to supply supplemental power to electrical loads to mitigate a swing past the threshold amount from the steady state electrical current caused by the instantaneous i) startup electrical currents and/or ii) other in-rush electrical currents back to the steady state electrical current; and thus, prevent the swing from the steady state electrical current caused by the instantaneous i) startup electrical currents and/or ii) other in-rush electrical currents from reaching and affecting electrical equipment loads connected to the battery energy storage supplemental power platform. The BESSP platform 100 supports example large motor operations. The BESSP platform 100 supports the various operational phases of a large motor during a typical operation.

In this example, a motor for a drill rig starts a lift of a heavy load. At point 1, the BESSP platform 100 supplies supplemental power for the initial seven seconds. In this example, the silicon-ion batteries, as opposed to a lithium ion, or other battery chemistries to provide a rapid discharge of energy from the battery plant. At point 2 to point 3, the supplemental power from the batteries makes up the amperage needed from the average of a little above 1500 amps to about 2600 amps (an 1100 amp difference required by the electrical load) without a dip in voltage level to fill the example gap of seven seconds. After the initial surge of amperage at 2600 amps, the amperage needed from points 3 to 5 decreases back down to a little above 1500 amps (jumping between points of 1600-1800 amps) which the main DC power source can supply without any swing in voltage level. Another graph lines shows that the motor can operate at a constant speed for the next 25 seconds until it drops off its heavy load. During this time the main DC power can charge the batteries of the BESSP platform 100 to restore its charge level. Thus, during periods 3-5, the electronic controller can switch the mode of the equipment on the BESSP platform from discharging over to charging the batteries until they are full.

The following details the energy requirements of the BESSP during the motor operations:
1. Initial Startup.
   a. 6.6 MJ
   b. 946 kW @7 s
   c. 910A
2. Constant Speed
   a. 46.6 MJ
   b. 710 kW @ 65.9 s
   c. 683A
3. Slow Down [Battery Recharge]
   a. 1.44 MJ
   b. 209 kW @ 7 s
   c. 198A

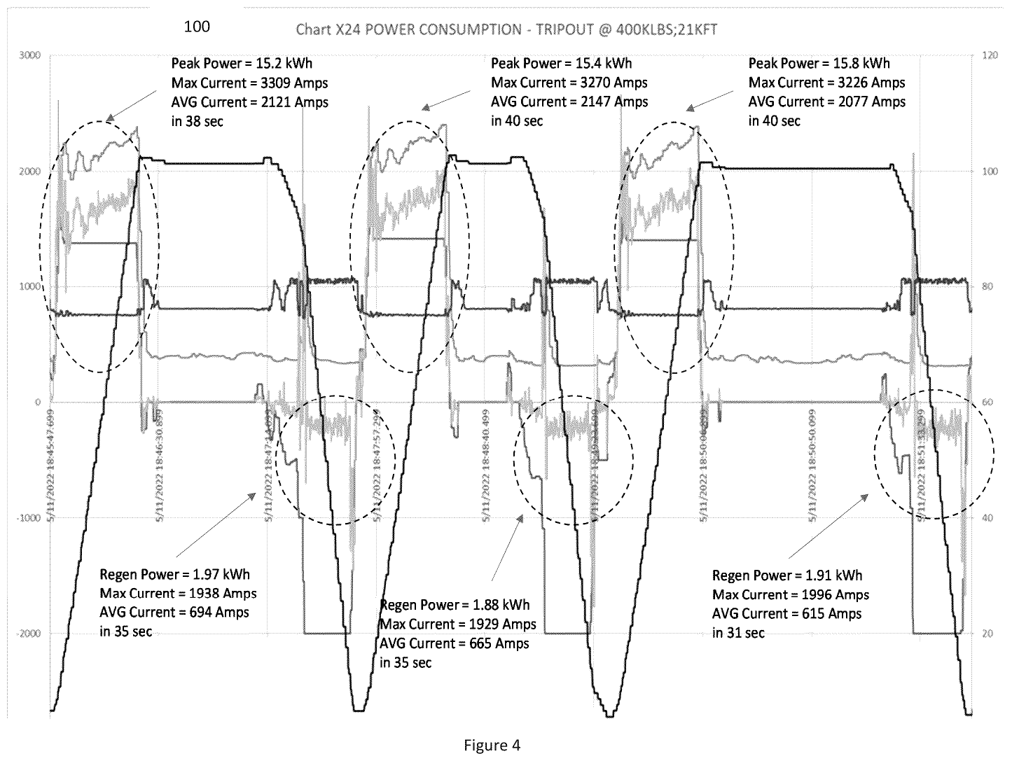

FIG. 4 illustrates another example application of the BESSP platform 100 to supply supplemental power to electrical loads and discharge the batteries making up the battery storage plant when a threshold amount of the instantaneous i) startup electrical currents and/or ii) other in-rush electrical currents compared to the steady state electrical current is sensed. The BESSP platform 100 supports other large motor applications over an example sequence of several heavy load operations.

An example application of the BESSP platform 100 is presented in FIG. 4 above. It shows the BESSP platform 100 in support of the various operational phases of a large motor during a typical operation. Three (3) surges occur requiring the BESSP to rapidly discharge large amounts of current to meet the instantaneous load demand follow by a corresponding dip where the batteries of the BSSP recharge. The three (3) surges are indicated by dotted oval lines around the three graph lines. The top graph line shows the graph for peak power. In this example, a peak power of 15.2 kilowatt hours is needed for a duration of 38 seconds. The second graph below the peak power graph is the maximum/peak required current graph. In the example the maximum current needed is 3309 amps. The third graph being shown is the average/steady state amperage being consumed before the large motor started up its operations. The steady state amperage/average current during this 38 second period is 2121 amps required for all of the other electrical loads consuming power outside of this large motor. The large motor is not operated on a continuous basis but rather in short spurts of time when initially picking up a heavy load or setting down a heavy load, etcetera. During the first power surge during the initial moments of that power surge to get to the maximum current of 3309 amps the batteries discharge to locally provide the amperage needed to get from the steady state 2121 amps to instantaneous peak current of 3309 amps. Note, during the lag between the main power source sensing the increase in need for more power the supplemental power comes from the batteries. After the first surge indicated by the oval dotted line, a period of time occurs in which the electronic controller can switch the mode of operation from the BEESP platform 100 over to recharging the batteries. Accordingly, the first oval circular dotted line shows the recharge operation of regenerative power of 1.97 kilowatt hours and a maximum current of 1938 amps and average current of 694 amps during that time period of approximately 35 seconds while the batteries are charging back to a fully charged state. This process repeats itself two more times as a surge occurs, from a steady state amperage draw by the other electrical loads connected to that power line, when the large motor needs to start up and move the heavy load. And then, the surge is done and after a period of time, then the electronic controller starts the charging of the batteries in the platform. Again, the discharging of the batteries is indicated by the graphs contained in the dotted ovals and the charging of the batteries is indicated by the graphs of power needed contained in the circular dotted lines. The following details the energy requirements of the BESSP platform 100 during the motor operations:
1. Motor Startup.
   a. 54.7 MJ
   b. 1.44 kW @38 s
   c. 1385A
2. Slow Down [Battery Recharge]
   a. 7.1 MJ
   b. 303.6 kW @ 35 s
   c. 195A
3. Motor Startup.
   a. 55.4 MJ
   b. 1.33 kW @40 s
   c. 1333A
4. Slow Down [Battery Recharge]
   a. 6.8 MJ
   b. 194.4 kW @ 35 s
   c. 185A
5. Motor Startup.
   a. 56 MJ
   b. 1.3 kW @40 s
   c. 1365A
6. Slow Down [Battery Recharge]
   a. 6.24 MJ
   b. 221.8 kW @ 5 s
   c. 213A

The BESSP's 3000A DC output is connected directly to the application's primary DC bus. The BESSP system features 52.5 MJ of storage. The graphs in the above applications indicate the amount of ESS energy required in each application. The Silicon-ion batteries in the BESSP system have been sized in capacity to have sufficient energy for two times the maximum amperage/peak power surges. In the example, an 1100 amp difference was needed to make up for the instantaneous electrical inrush current. Thus, for this example, the Silicon-ion batteries could be sized in capacity to handle a 2200 amp discharge without any change in the performance of the batteries. For example, an excessive amount is available for application 1 in FIG. 3 and an equivalent amount of power is required by application 2 in FIG. 4. The Silicon-ion batteries can deliver the amount of energy [e.g. Mega Joules] in the short time frames shown in each application. The batteries re-charge any time the system is shown to be slowing or when there are no excessive demands to support.

The containerized BESSP is field deployable. It can be easily transported to any location anywhere around the globe. It is a fully self-contained system. All consumable power is supplied from the BESSP's internal DC collective bus.

An instance of the integrated electrical power unit is constructed to be scalable in an amount of capacity over time of its operation by having one or more electrical connections to add on an additional electrical power capacity by adding at least one of 1) another new set of back-up batteries and a new power conversion and conditioning module electrically in parallel to an existing set of electrical components (back-up batteries and a power conversion and conditioning module) of the integrated electrical unit. The new and existing electrical components all connect to the same output circuit breaker, which is already installed and 2) an expansion connection to add a number of blocks of back-up batteries to existing back-up batteries in the battery storage plant for that integrated electrical unit. Each integrated electrical power unit can have a scalable amount of batteries, electrically connected in series-parallel, to be able to supply electrical power for the electrical loads.

The controller of the integrated electrical power unit has a remote electrical tap and sensor to sense characteristics of the AC power coming from the main AC power source. The sensing of the AC power on this input feed line occurs far enough upstream from the electrical connection/feed to the electrical loads so that voltage swings is countered by the time the power is supplied to the electrical loads. The sensing of the mains can be done with a sensor configured to sense both voltage and amperage levels. Both voltage and amperage are measured inside the sensor. When any of these parameters go outside allowable limits, then the controller acts to supply supplemental power from the power converter module of the BESSP.

The electrical power conversion and conditioning module can include a bi-directional inverter which can use utility power to charge the systems batteries.

Each battery backup power pack may be located in a conditioned room at a controlled temperature and have its own dedicated cooling system.

The batteries of the BESSP platform 100 are less expensive to purchase, operate, and maintain than the life cycle the capacitors.

Heavy equipment like drill rigs and cranes that need supplemental power can be mobile and the BESSP platform 100 is constructed to be mobile as well. Additionally, the heavy equipment works outdoors and exposed to the weather and so the BESSP platform 100 is constructed to withstand the weather in its weatherized container. Again, the container is constructed to control the heat and dissipate the heat from the constant discharging and charging.

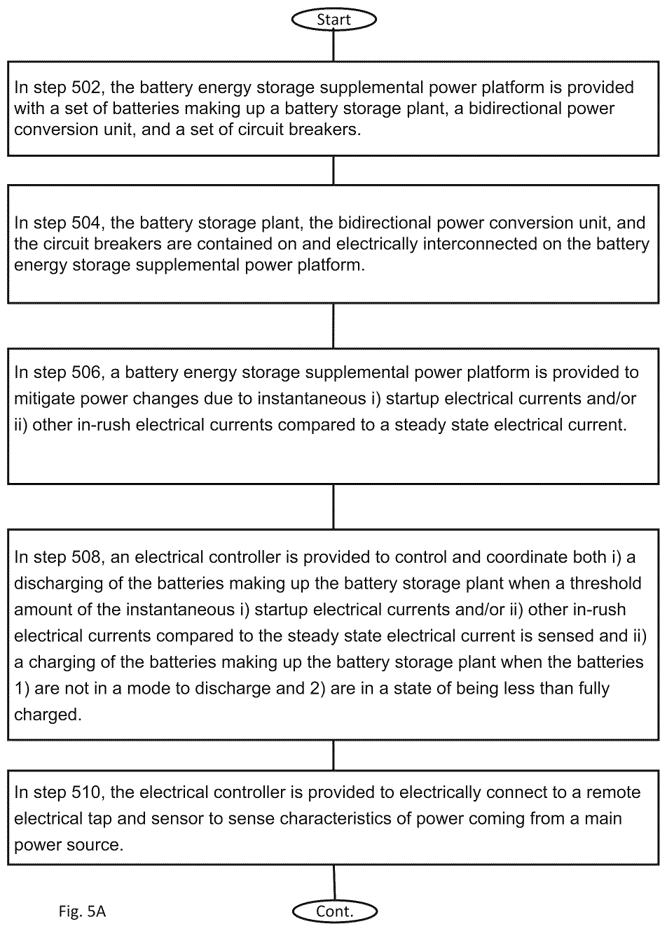

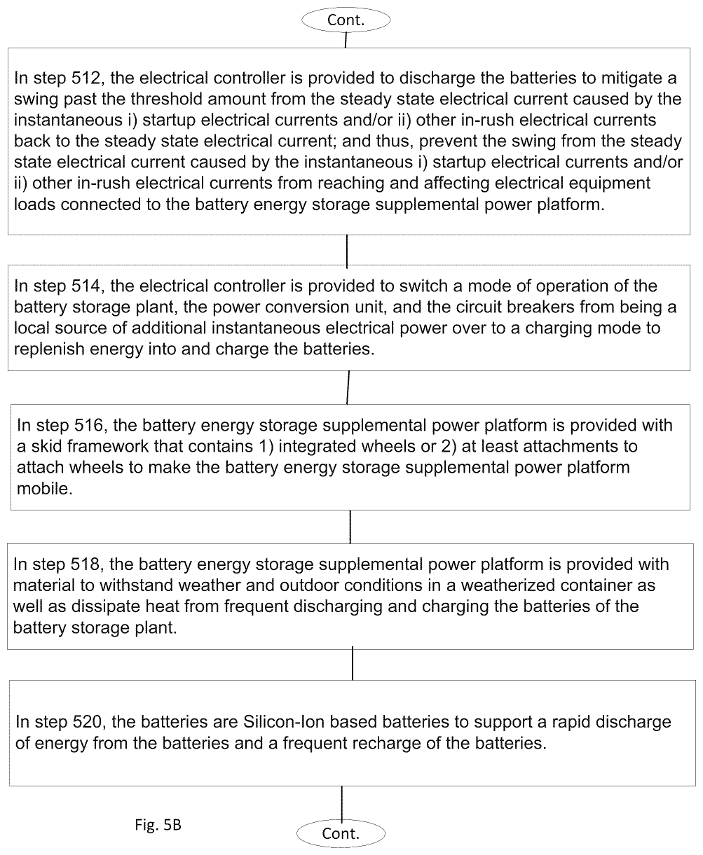

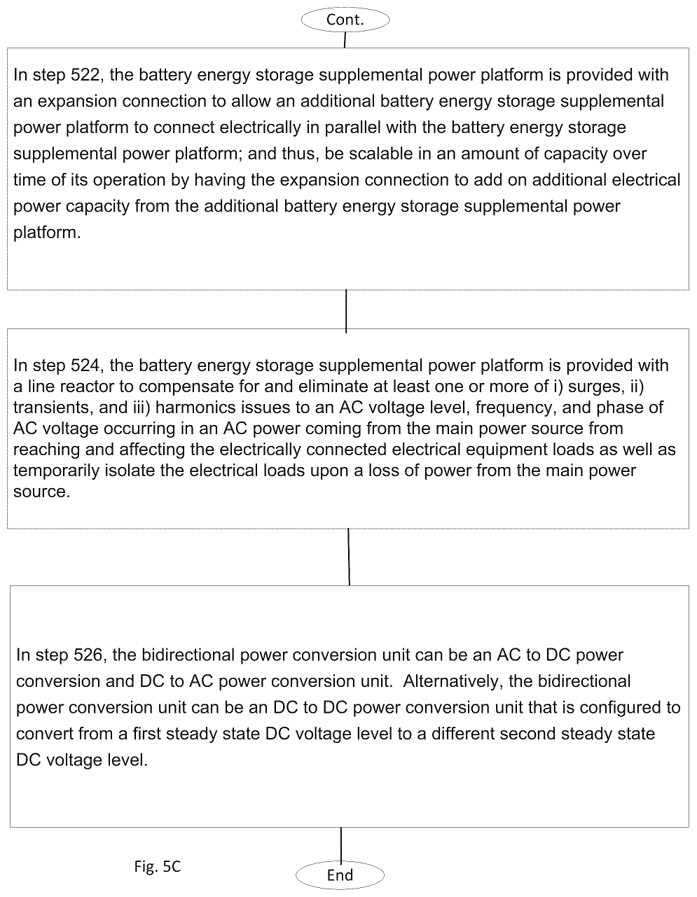

FIGS. 5A-5C illustrate a flow diagram of example operations of the BESSP platform.

In step 502, the battery energy storage supplemental power platform is provided with a set of batteries making up a battery storage plant, a bidirectional power conversion unit, and a set of circuit breakers.

In step 504, the battery storage plant, the bidirectional power conversion unit, and the circuit breakers are contained on and electrically interconnected on the battery energy storage supplemental power platform.

In step 506, a battery energy storage supplemental power platform is provided to mitigate power changes due to instantaneous i) startup electrical currents and/or ii) other in-rush electrical currents compared to a steady state electrical current.

In step 508, an electrical controller is provided to control and coordinate both i) a discharging of the batteries making up the battery storage plant when a threshold amount of the instantaneous i) startup electrical currents and/or ii) other in-rush electrical currents compared to the steady state electrical current is sensed and ii) a charging of the batteries making up the battery storage plant when the batteries 1) are not in a mode to discharge and 2) are in a state of being less than fully charged.

In step 510, the electrical controller is provided to electrically connect to a remote electrical tap and sensor to sense characteristics of power coming from a main power source.

In step 512, the electrical controller is provided to discharge the batteries to mitigate a swing past the threshold amount from the steady state electrical current caused by the instantaneous i) startup electrical currents and/or ii) other in-rush electrical currents back to the steady state electrical current; and thus, prevent the swing from the steady state electrical current caused by the instantaneous i) startup electrical currents and/or ii) other in-rush electrical currents from reaching and affecting electrical equipment loads connected to the battery energy storage supplemental power platform.

In step 514, the electrical controller is provided to switch a mode of operation of the battery storage plant, the power conversion unit, and the circuit breakers from being a local source of additional instantaneous electrical power over to a charging mode to replenish energy into and charge the batteries.

In step 516, the battery energy storage supplemental power platform is provided with a skid framework that contains 1) integrated wheels or 2) at least attachments to attach wheels to make the battery energy storage supplemental power platform mobile.

In step 518, the battery energy storage supplemental power platform is provided with material to withstand weather and outdoor conditions in a weatherized container as well as dissipate heat from frequent discharging and charging the batteries of the battery storage plant.

In step 520, the batteries are Silicon-Ion based batteries to support a rapid discharge of energy from the batteries and a frequent recharge of the batteries.

In step 522, the battery energy storage supplemental power platform is provided with an expansion connection to allow an additional battery energy storage supplemental power platform to connect electrically in parallel with the battery energy storage supplemental power platform; and thus, be scalable in an amount of capacity over time of its operation by having the expansion connection to add on additional electrical power capacity from the additional battery energy storage supplemental power platform.

In step 524, the battery energy storage supplemental power platform is provided with a line reactor to compensate for and eliminate at least one or more of i) surges, ii) transients, and iii) harmonics issues to an AC voltage level, frequency, and phase of AC voltage occurring in an AC power coming from the main power source from reaching and affecting the electrically connected electrical equipment loads as well as temporarily isolate the electrical loads upon a loss of power from the main power source.

In step 526, the bidirectional power conversion unit can be an AC to DC power conversion and DC to AC power conversion unit. Alternatively, the bidirectional power conversion unit can be an DC to DC power conversion unit that is configured to convert from a first steady state DC voltage level to a different second steady state DC voltage level.

### Computing Devices

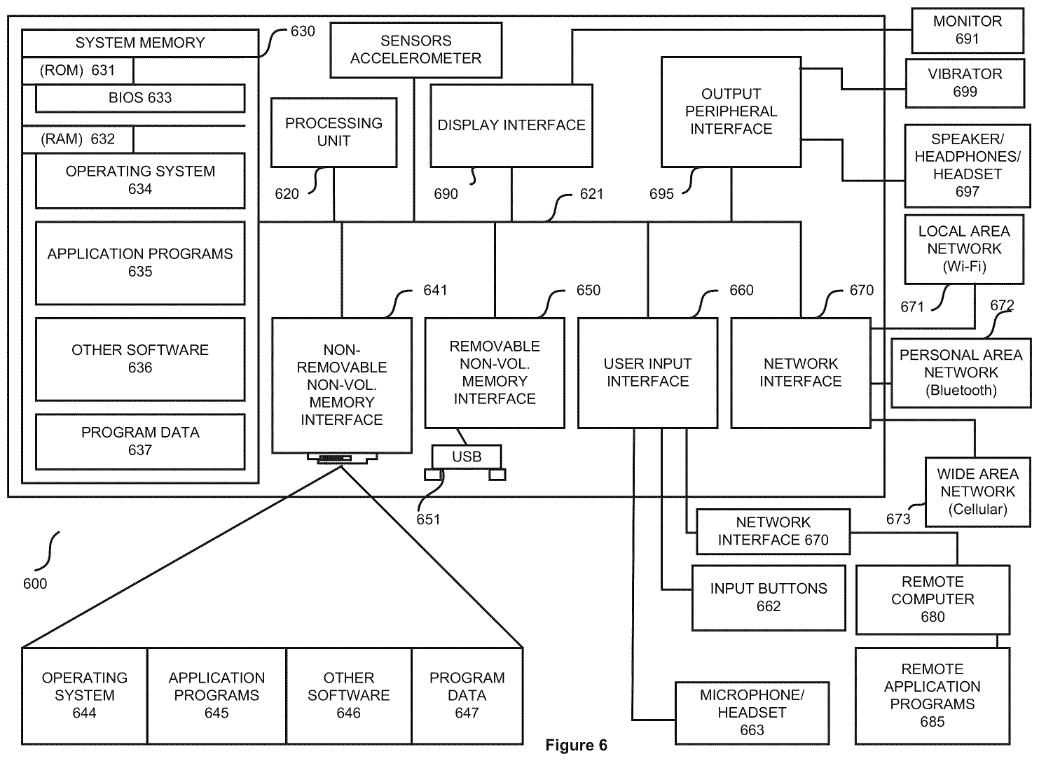

FIG. 6 illustrates a block diagram of an embodiment of one or more computing devices that can be a part of the electronic controller and other parts of the BESSP platform 100 discussed herein.

The computing device may include one or more processors or processing units 620 to execute instructions, one or more memories 630-632 to store information, one or more data input components 660-663 to receive data input from a user of the computing device 600, one or more modules that include the management module, a network interface communication circuit 670 to establish a communication link to communicate with other computing devices external to the computing device, one or more sensors where an output from the sensors is used for sensing a specific triggering condition and then correspondingly generating one or more preprogrammed actions, a display screen 691 to display at least some of the information stored in the one or more memories 630-632 and other components. Note, portions of this design implemented in software 644, 645, 646 are stored in the one or more memories 630-632 and are executed by the one or more processors 620. The processing unit 620 may have one or more processing cores, which couples to a system bus 621 that couples various system components including the system memory 630. The system bus 621 may be any of several types of bus structures selected from a memory bus, an interconnect fabric, a peripheral bus, and a local bus using any of a variety of bus architectures.

Computing device 602 typically includes a variety of computing machine-readable media. Machine-readable media can be any available media that can be accessed by computing device 602 and includes both volatile and nonvolatile media, and removable and non-removable media. By way of example, and not limitation, computing machine-readable media use includes storage of information, such as computer-readable instructions, data structures, other executable software, or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, and which can be accessed by the computing device 602. Transitory media such as wireless channels are not included in the machine-readable media. Machine-readable media typically embody computer readable instructions, data structures, and other executable software. In an example, a volatile memory drive 641 is illustrated for storing portions of the operating system 644, application programs 645, other executable software 646, and program data 647.

A user may enter commands and information into the computing device 602 through input devices such as a keyboard, touchscreen, or software or hardware input buttons 662, a microphone 663, a pointing device and/or scrolling input component, such as a mouse, trackball, or touch pad 661. The microphone 663 can cooperate with speech recognition software. These and other input devices are often connected to the processing unit 620 through a user input interface 660 that is coupled to the system bus 621, but can be connected by other interface and bus structures, such as a lighting port, game port, or a universal serial bus (USB). A display monitor 691 or other type of display screen device is also connected to the system bus 621 via an interface, such as a display interface 690. In addition to the monitor 691, computing devices may also include other peripheral output devices such as speakers 697, a vibration device 699, and other output devices, which may be connected through an output peripheral interface 695.

The computing device 602 can operate in a networked environment using logical connections to one or more remote computers/client devices, such as a remote computing system 680. The remote computing system 680 can a personal computer, a mobile computing device, a server, a router, a network PC, a peer device, or other common network node, and typically includes many or all of the elements described above relative to the computing device 602. The logical connections can include a personal area network (PAN) 672 (e.g., Bluetooth®), a local area network (LAN) 671 (e.g., Wi-Fi), and a wide area network (WAN) 673 (e.g., cellular network). Such networking environments are commonplace in offices, enterprise-wide computer networks, intranets, and the Internet. A browser application and/or one or more local apps may be resident on the computing device and stored in the memory.

When used in a LAN networking environment, the computing device 602 is connected to the LAN 671 through a network interface 670, which can be, for example, a Bluetooth® or Wi-Fi adapter. When used in a WAN networking environment (e.g., Internet), the computing device 602 typically includes some means for establishing communications over the WAN 673. With respect to mobile telecommunication technologies, for example, a radio interface, which can be internal or external, can be connected to the system bus 621 via the network interface 670, or other appropriate mechanism. In a networked environment, other software depicted relative to the computing device 602, or portions thereof, may be stored in the remote memory storage device. By way of example, and not limitation, remote application programs 685 as reside on remote computing device 680. It will be appreciated that the network connections shown are examples and other means of establishing a communications link between the computing devices that may be used. It should be noted that the present design can be carried out on a single computing device or on a distributed system in which different portions of the present design are carried out on different parts of the distributed computing system.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A software engine is a core component of a complex system consisting of hardware and software that is capable of performing its function discretely from other portions of the entire complex system but designed to interact with the other portions of the entire complex system.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the invention have been shown, the invention is not to be limited to these embodiments. For example, most functions performed by electronic hardware components may be duplicated by software emulation. Thus, a software program written to accomplish those same functions may emulate the functionality of the hardware components in input-output circuitry. The type of cabinets may vary, etc. The invention is to be understood as not limited by the specific embodiments described herein, but only by scope of the appended claims.

1. An apparatus, comprising:
a battery energy storage supplemental power platform configured to mitigate power changes due to instantaneous i) startup electrical currents and/or ii) other in-rush electrical currents compared to a steady state electrical current, where the battery energy storage supplemental power platform has a set of batteries making up a battery storage plant, a bidirectional power conversion unit, and a set of circuit breakers, where the battery storage plant, the bidirectional power conversion unit, and the circuit breakers are contained on and electrically interconnected on the battery energy storage supplemental power platform,
an electrical controller configured to control and coordinate both i) a discharging of the batteries making up the battery storage plant when a threshold amount of the instantaneous i) startup electrical currents and/or ii) other in-rush electrical currents compared to the steady state electrical current is sensed and ii) a charging of the batteries making up the battery storage plant when the batteries 1) are not in a mode to discharge and 2) are in a state of being less than fully charged, and
where the electrical controller is electrically connected to a remote electrical tap and sensor to sense characteristics of power coming from a main power source, where the electrical controller is configured to discharge the batteries to mitigate a swing past the threshold amount from the steady state electrical current caused by the instantaneous i) startup electrical currents and/or ii) other in-rush electrical currents back to the steady state electrical current; and thus, prevent the swing from the steady state electrical current caused by the instantaneous i) startup electrical currents and/or ii) other in-rush electrical currents from reaching and affecting electrical equipment loads connected to the battery energy storage supplemental power platform.

2. The apparatus of claim 1, where the battery energy storage supplemental power platform is constructed with material to withstand weather and outdoor conditions in a weatherized container as well as dissipate heat from frequent discharging and charging the batteries of the battery storage plant.

3. The apparatus of claim 2, where the battery energy storage supplemental power platform has a skid framework that contains 1) integrated wheels or 2) at least attachments to attach wheels to make the battery energy storage supplemental power platform mobile.

4. The apparatus of claim 1, where the batteries are Silicon-Ion based batteries to support a rapid discharge of energy from the batteries and a frequent recharge of the batteries, and the electrical controller is configured to switch a mode of operation of the battery storage plant, the power conversion unit, and the circuit breakers from being a local source of additional instantaneous electrical power over to a charging mode to replenish energy into and charge the batteries.

5. The apparatus of claim 1, where the battery energy storage supplemental power platform has an expansion connection to allow an additional battery energy storage supplemental power platform to connect electrically in parallel with the battery energy storage supplemental power platform; and thus, be scalable in an amount of capacity over time of its operation by having the expansion connection to add on additional electrical power capacity from the additional battery energy storage supplemental power platform.

6. The apparatus of claim 1, where the battery energy storage supplemental power platform has a line reactor to compensate for and eliminate at least one or more of i) surges, ii) transients, and iii) harmonics issues to an AC voltage level, frequency, and phase of AC voltage occurring in an AC power coming from the main power source from reaching and affecting the electrically connected electrical equipment loads.

7. The apparatus of claim 1, where the bidirectional power conversion unit is an AC to DC power conversion and DC to AC power conversion unit.

8. The apparatus of claim 1, where the bidirectional power conversion unit is an DC to DC power conversion unit that is configured to convert from a first steady state DC voltage level to a different second steady state DC voltage level.

9. A method for supplying power, comprising:
providing a battery energy storage supplemental power platform to mitigate power changes due to instantaneous i) startup electrical currents and/or ii) other in-rush electrical currents compared to a steady state electrical current,
providing the battery energy storage supplemental power platform with a set of batteries making up a battery storage plant, a bidirectional power conversion unit, and a set of circuit breakers,
providing the battery storage plant, the bidirectional power conversion unit, and the circuit breakers contained on and electrically interconnected on the battery energy storage supplemental power platform,
providing an electrical controller to control and coordinate both i) a discharging of the batteries making up the battery storage plant when a threshold amount of the instantaneous i) startup electrical currents and/or ii) other in-rush electrical currents compared to the steady state electrical current is sensed and ii) a charging of the batteries making up the battery storage plant when the batteries 1) are not in a mode to discharge and 2) are in a state of being less than fully charged,
providing the electrical controller to electrically connect to a remote electrical tap and sensor to sense characteristics of power coming from a main power source, and
providing the electrical controller to discharge the batteries to mitigate a swing past the threshold amount from the steady state electrical current caused by the instantaneous i) startup electrical currents and/or ii) other in-rush electrical currents back to the steady state electrical current; and thus, prevent the swing from the steady state electrical current caused by the instantaneous i) startup electrical currents and/or ii) other in-rush electrical currents from reaching and affecting electrical equipment loads connected to the battery energy storage supplemental power platform.

10. The method of claim 9, further comprising:
providing the battery energy storage supplemental power platform with material to withstand weather and outdoor conditions in a weatherized container as well as dissipate heat from frequent discharging and charging the batteries of the battery storage plant.

11. The method of claim 10, further comprising:
providing the battery energy storage supplemental power platform with a skid framework that contains 1) integrated wheels or 2) at least attachments to attach wheels to make the battery energy storage supplemental power platform mobile.

12. The method of claim 9, where the batteries are Silicon-Ion based batteries to support a rapid discharge of energy from the batteries and a frequent recharge of the batteries, and
providing the electrical controller to switch a mode of operation of the battery storage plant, the power conversion unit, and the circuit breakers from being a local source of additional instantaneous electrical power over to a charging mode to replenish energy into and charge the batteries.

13. The method of claim 9, further comprising:
providing the battery energy storage supplemental power platform with an expansion connection to allow an additional battery energy storage supplemental power platform to connect electrically in parallel with the battery energy storage supplemental power platform; and thus, be scalable in an amount of capacity over time of its operation by having the expansion connection to add on additional electrical power capacity from the additional battery energy storage supplemental power platform.

14. The method of claim 9, further comprising:
providing the battery energy storage supplemental power platform with a line reactor to compensate for and eliminate at least one or more of i) surges, ii) transients, and iii) harmonics issues to an AC voltage level, frequency, and phase of AC voltage occurring in an AC power coming from the main power source from reaching and affecting the electrically connected electrical equipment loads.

15. The method of claim 9, where the bidirectional power conversion unit is an AC to DC power conversion and DC to AC power conversion unit.

16. The method of claim 9, where the bidirectional power conversion unit is an DC to DC power conversion unit that is configured to convert from a first steady state DC voltage level to a different second steady state DC voltage level.
